(19) United States
(12) Patent Application Publication
(10) Pub. No.: US 2025/0096569 A1
(43) Pub. Date: Mar. 20, 2025

(54) AC/DC POWER DISTRIBUTION SYSTEM FOR DATA CENTER

(71) Applicant: Hebei Qinhuai Data Co., Limited., Zhangjiakou City (CN)

(72) Inventor: Binghua ZHANG, Zhangjiakou City (CN)

(21) Appl. No.: 18/817,027

(22) Filed: Aug. 27, 2024

(30) Foreign Application Priority Data
Sep. 19, 2023 (CN) 202311210835.5

(51) Int. Cl. H02J 3/32; G06F 1/30; H02J 3/02; H02J 3/38; H02J 9/00

(52) U.S. Cl. CPC H02J 3/32; G06F 1/305; H02J 3/02; H02J 3/38; H02J 9/00; H02J 2300/24

(57) ABSTRACT

The present disclosure disclose an AC/DC power distribution system for a data center, including: a power supply module, a control module, a DC output module, an AC output module, an energy storage module, and a backup power module. The control module includes a first rectifier unit, a first inverter unit, a power electronic transformer, a second rectifier unit, and a second inverter unit. The first rectifier unit is connected to the power supply module, and the first inverter unit. The energy storage module is connected between the first rectifier unit and the first inverter unit, where the first inverter unit is connected to the power electronic transformer, and the power electronic transformer is connected to the second rectifier unit, which is separately connected to the DC output module and the second inverter unit. The backup power module is connected between the second rectifier unit and the second inverter unit.

### CROSS REFERENCE TO RELATED APPLICATION

This application claims priority to Chinese Patent Application No. 202311210835.5, titled “AC/DC POWER DISTRIBUTION SYSTEM FOR DATA CENTER” and filed to the China National Intellectual Property Administration on Sep. 19, 2023, the entire contents of which are incorporated herein by reference.

### TECHNICAL FIELD

The present disclosure relates to the field of power supply and distribution technology, and more particularly, to an AC/DC power distribution system for a data center.

### BACKGROUND

With the proposal of China's “Dual Carbon” goals, the concept of green, low-carbon and energy-saving will inevitably become the development direction of future data centers.

At present, traditional power supply and distribution systems have long chains. Electrical energy is introduced from power grid lead-in through high-voltage distribution devices, transformers, low-voltage distribution devices, uninterruptible power supply (UPS) to load devices, which is lower in efficiency. To achieve uninterrupted power supply, a backup battery is arranged on the UPS, which may cause waste of resources when the battery is idle for a long time. Moreover, the traditional power supply and distribution systems are comprised of a plurality of devices, occupy a large area and have low degree of integration, and require for on-site construction, resulting in a longer construction period. As the proportion of green electricity in power grids increases, peak-valley electricity price differences increases, and energy storage technologies will be effectively integrated in data centers. However, currently, the traditional power supply and distribution systems are not compatible with the energy storage technologies.

### SUMMARY

To solve the existing technical problems, embodiments of the present disclosure provide an AC/DC power distribution system for a data center. The technical solutions are described as follows.

In a first aspect, there is provided an AC/DC power distribution system for a data center, which includes a power supply module, a control module, a DC output module, an AC output module, an energy storage module, and a backup power module.

The control module includes a first rectifier unit, a first inverter unit, a power electronic transformer, a second rectifier unit, and a second inverter unit.

One end of the first rectifier unit is connected to the power supply module, and other end of the first rectifier unit is connected to the first inverter unit. The energy storage module is also connected between the first rectifier unit and the first inverter unit. The first inverter unit is connected to the power electronic transformer, which is connected to the second rectifier unit. The second rectifier unit is separately connected to the DC output module and the second inverter unit. The backup power module is also connected between the second rectifier unit and the second inverter unit.

Further, the power supply module includes a mains power grid or a generator.

Further, the energy storage module includes a DC transformer unit at an energy storage end, which is configured to transform a voltage for a direct current inputted to the energy storage module or outputted from the energy storage module.

Further, the energy storage module includes an energy storage device.

Further, the energy storage device includes a battery pack or a photovoltaic device.

Further, the backup power module includes a DC transformer unit at a backup power end, which is configured to transform a voltage for a direct current inputted to the backup power module or outputted from the backup power module.

Further, the backup power module includes a backup power device.

Further, the backup power device includes a battery pack.

Further, the DC output module is configured to supply power to an IT load having a DC voltage of 240V/336V.

Further, the AC output module is configured to supply power to a power load having an AC voltage of 380V.

The technical solutions provided by the embodiments of the present disclosure achieve the following beneficial effects.

In the embodiments of the present disclosure, the AC/DC power distribution system for the data center includes a power supply module, a control module, a DC output module, an AC output module, an energy storage module, and a backup power module. The control module includes a first rectifier unit, a first inverter unit, a power electronic transformer, a second rectifier unit, and a second inverter unit. One end of the first rectifier unit is connected to the power supply module, and other end of the first rectifier unit is connected to the first inverter unit. The energy storage module is also connected between the first rectifier unit and the first inverter unit, where the first inverter unit is connected to the power electronic transformer, and the power electronic transformer is connected to the second rectifier unit, which is separately connected to the DC output module and the second inverter unit. The backup power module is also connected between the second rectifier unit and the second inverter unit. By arranging a three-level PET topology structure, the present disclosure optimizes a power supply and distribution system link and integrates an energy storage device, such that the power supply module, the energy storage module, the backup power module, the AC output module, and the DC output module are connected to each other. Based on detection and recognition of current power supply and distribution, the control module supplies AC/DC power to a load device by means of the power supply module, the energy storage module, and the backup power module according to demands, thereby avoiding occurrence of intermittent power supply during electricity consumption peak or power outage. In this way, efficiency of the power supply system is improved, energy efficiency is maximized, and rational allocation of resources is ensured.

### BRIEF DESCRIPTION OF THE DRAWINGS

To describe the technical solutions of the embodiments of the present disclosure more clearly, the accompanying drawings required in the description of the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic structural diagram of an AC/DC power distribution system for a data center according to an embodiment of the present disclosure;

FIG. 2 is a schematic diagram of a first type of power supply routing of an AC/DC power distribution system for a data center according to an embodiment of the present disclosure;

FIG. 3 is a schematic diagram of a second type of power supply routing of an AC/DC power distribution system for a data center according to an embodiment of the present disclosure;

FIG. 4 is a schematic diagram of a third type of power supply routing of an AC/DC power distribution system for a data center according to an embodiment of the present disclosure; and

FIG. 5 is a schematic diagram of a fourth type of power supply routing of an AC/DC power distribution system for a data center according to an embodiment of the present disclosure.

### DETAILED DESCRIPTION

To make the objectives, technical solutions and advantages of the present disclosure clearer, the embodiments of the present disclosure will be further described in detail below with reference to the accompanying drawings.

It should be clear that the described embodiments are some but not all of the embodiments of the present disclosure. All other embodiments obtained by a person of ordinary skill in the art based on the embodiments of the present disclosure without creative efforts shall fall within the protection scope of the present disclosure.

When accompanying drawings are mentioned in the following descriptions, the same numbers in different drawings represent the same or similar elements, unless otherwise represented. The implementations set forth in the following description of exemplary embodiments do not represent all implementations consistent with the present disclosure. Instead, they are merely examples of apparatuses and methods consistent with some aspects related to the present disclosure as recited in the appended claims.

In the description of the present disclosure, it should be understood that the terms “first”, “second”, “third”, etc. are merely intended to separate between similar objects but are not intended to describe a specific sequence or precedence order, and are not construed as indicating or implying relative importance. The terms “installed”, “arranged”, “provided”, “connected”, “slidably connected”, “fixed”, and “sleeved” should be understood in a broad sense. For example, “connection” may be a fixed connection, a detachable connection or integrated connection, a mechanical connection or an electrical connection, a direct connection or indirect connection by means of an intermediary, or internal communication between two apparatuses, elements, or constituent parts. The specific significations of the above terms in the present disclosure may be understood in the light of specific conditions by persons of ordinary skill in the art. The specific significations of the above terms in the present disclosure may be understood in the light of specific conditions by persons of ordinary skill in the art. Furthermore, in the description of the present disclosure, unless otherwise specified, “a plurality of” refers to two or more.

The AC/DC power distribution system for the data center of the present disclosure includes a power electronic transformer (PET), a rectifier unit, an inverter unit, and a DC transformer unit. By means of a three-level PET topology structure, electrical energy of one power characteristic is transformed into electrical energy of another power characteristic after being processed by the rectifier unit, the inverter unit, and the DC transformer unit. That is, conversion between AC and DC is achieved. The rectifier unit is configured to convert alternating current into direct current, which is also known as AC/DC conversion, and power flow of this conversion is transmitted from a power source to a load. The inverter unit is configured to convert the direct current into the alternating current, which is also known as DC/AC conversion. The inverter unit may be configured to form various AC power sources and is widely used in industry. By introducing power transformation technology and control technology, the power electronic transformer can flexibly process and control an amplitude and a phase of a voltage or current of primary and secondary sides of a transformer, and can control the power flow of the system according to actual needs. Furthermore, after the power electronic transformer is connected to a battery, reliability of power supply can be improved; The power electronic transformer has better input-output characteristics under conditions such as full-load rated operation, one-phase disconnection on a low-voltage side, three-phase short circuit, and three-phase imbalance and harmonic pollution on a high-voltage side. This can avoid adverse impacts of imbalance of a system on one side to a system on the other side. Therefore, the power electronic transformer has better performance than conventional power transformers, and the power electronic transformer can achieve more stable and flexible power transmission.

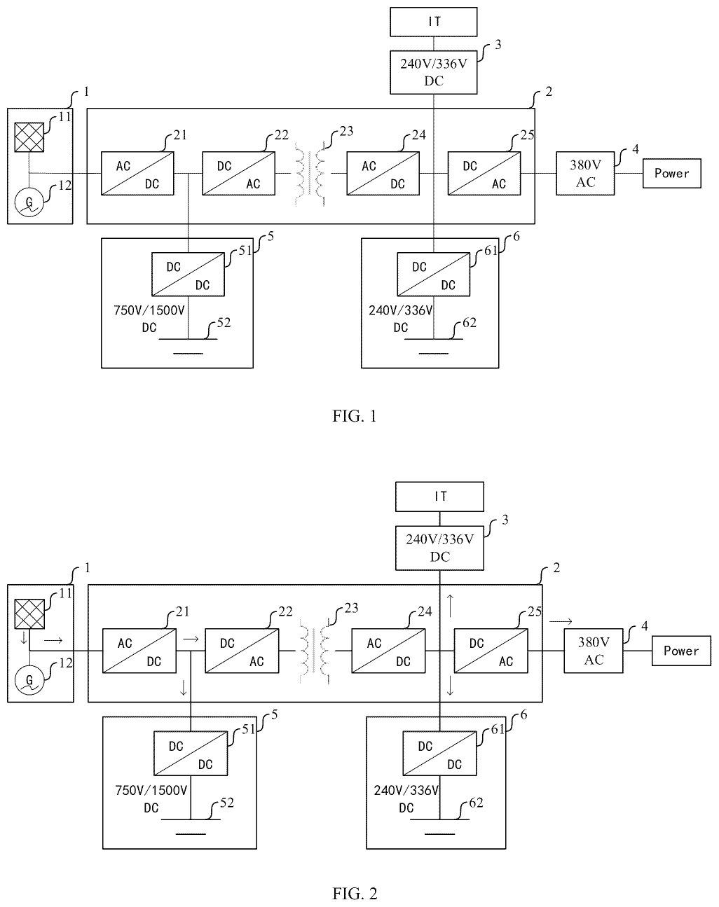

As shown in FIG. 1, the embodiments of the present disclosure provide an AC/DC power distribution system for a data center, including: a power supply module 1, a control module 2, a DC output module 3, an AC output module 4, an energy storage module 5, and a backup power module 6.

The control module 2 specifically includes a first rectifier unit 21, a first inverter unit 22, a power electronic transformer 23, a second rectifier unit 24, and a second inverter unit 25.

One end of the first rectifier unit 21 is connected to the power supply module 1, and other end of the first rectifier unit 21 is connected to the first inverter unit 22. The first rectifier unit 21 can receive alternating current transmitted from the power supply module 1, and convert the alternating current into direct current, and then transmit the direct current to the first inverter unit 22.

The power supply module 1 may include a conventional mains power grid 11, and also may include a generator 12 as a backup. Under normal circumstances, the mains power grid 11 can directly supply power to the AC/DC power distribution system for the data center by means of the power supply module 1. When the mains power grid 11 is in a state of power loss, the generator 12 can supply power to the AC/DC power distribution system for the data center by means of the power supply module 1. Access capacity of the power supply module 1 may be designed and configured according to specific subordinate loads to ensure uninterrupted power supply.

The energy storage module 5 is connected between the first rectifier unit 21 and the first inverter unit 22. The first rectifier unit 21 can transmit the converted direct current to the energy storage module 5, to charge an energy storage device 52 of the energy storage module 5. The energy storage device 52 can also transmit the direct current to the first inverter unit 22 by means of the energy storage module 5.

The energy storage module 5 includes a DC transformer unit 51 at an energy storage end, which can transform a voltage for the direct current inputted to the energy storage device 52 or outputted from the energy storage device 52. The energy storage module 5 may also include the energy storage device 52. In practice, a battery pack or a photovoltaic device may be used as the energy storage device 52.

The first inverter unit 22 is also connected to the power electronic transformer 23. After receiving the direct current transmitted from the first rectifier unit 21 or the energy storage module 5, the first inverter unit 22 can convert the direct current into alternating current, and then transmit the converted alternating current to the power electronic transformer 23.

The power electronic transformer 23 is also connected to the second rectifier unit 14. The power electronic transformer 13 reduces the voltage for the alternating current transmitted from the first inverter unit 22, and then transmits the alternating current to the second rectifier unit 24. The power electronic transformer 23 also has automatic and/or manual voltage regulation functions, which can improve power supply quality of the photovoltaic device.

The second rectifier unit 24 is connected to the DC output module 3 and the second inverter unit 25, respectively. After receiving the alternating current subjected to voltage reduction from the power electronic transformer 23, the second rectifier unit 25 converts the alternating current into the direct current. Next, in one aspect, the second rectifier unit 25 transmits the direct current to the DC output module 3, such that the DC output module 3 can supply power to an IT load having a DC voltage of 240V/336V. In another aspect, the second rectifier unit 25 transmits the direct current to the second rectifier unit 25.

The backup power module 6 is also connected between the second rectifier unit 24 and the second inverter unit 25. The second rectifier unit 24 may also transmit the converted direct current to the backup power module 6, to charge a backup power device 62 of the backup power module 6. The backup power device 62 may also transmit the direct current to the second inverter unit 25 by means of the backup power module 6.

The backup power module 6 includes a DC transformer unit 61 at a backup power end, which may transform the voltage for the direct current inputted to the backup power device 62 or outputted from the backup power device 62. The backup power module 6 may also include the backup power device 62. In practice, a battery pack may be used as the backup power device 62.

The second inverter unit 25 reconverts the direct current transmitted from the second rectifier unit 24 or the backup power module 6 into the alternating current, which is then transmitted to the AC output module 4 connected to the second inverter unit 25. The AC output module 4 can supply power to a power load having an AC voltage of 380V.

In the embodiments of the present disclosure, intelligent control switches (not shown in the figure) may also be electrically connected at connection points between the control module 2 and the power supply module 1, the DC output module 3, the AC output module 4, the energy storage module 5, and the backup power module 6. The control module 2 turns on/off the intelligent control switch of each port of a switch based on recognized current power situations, and regulates the AC/DC power distribution system for the data center, to reduce unnecessary waste of resources.

FIG. 2 shows a first type of power supply routing of the AC/DC power distribution system for the data center in the present disclosure. When the mains power grid 11 of the power supply module 1 is normal, the intelligent control switch remains an On state. The control module 2 controls the mains power grid 11 to supply power to the DC output module 3 and the AC output module 4, to supply power to the load device, and to supply power to the energy storage module 4 and the backup power module 5, serving as a reserve for charging these modules.

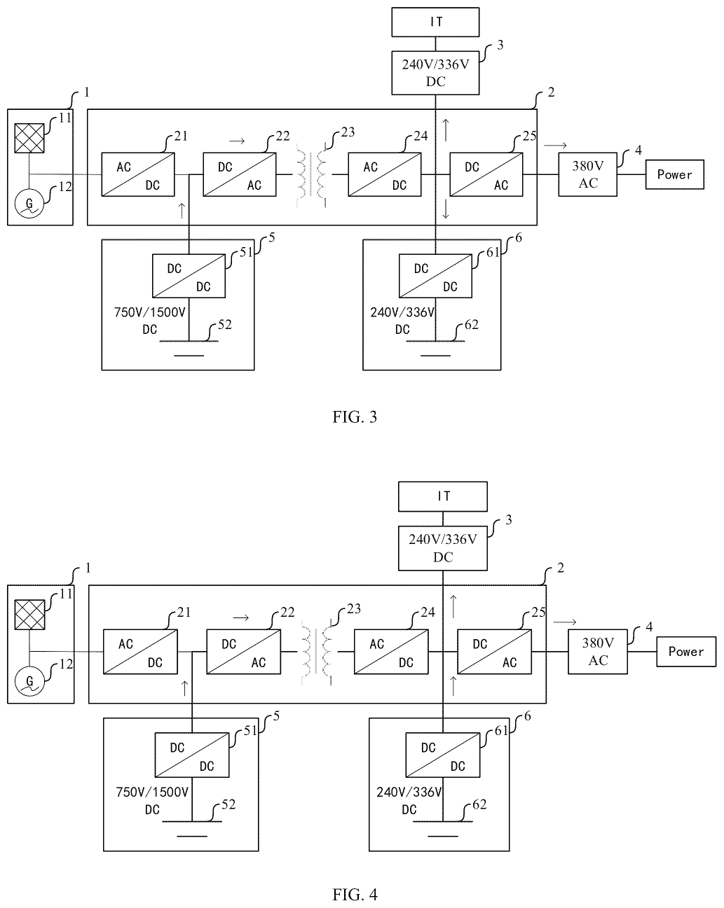

FIG. 3 shows a second type of power supply routing of the AC/DC power distribution system for the data center in the present disclosure. When the mains power grid 11 of the power supply module 1 is normal but it is recognized that it is currently in a period of higher electricity price, the intelligent control switch of the mains power grid 11 of the power supply module 1 is turned off. The control module 2 controls the energy storage module 4 to supply power to the DC output module 3 and the AC output module 4, to supply AC/DC power to the load device, to achieve peak shaving and valley filling, thereby minimizing electricity costs.

FIG. 4 shows a third type of power supply routing of the AC/DC power distribution system for the data center in the present disclosure. When the mains power grid 11 of the power supply module 1 is in the state of power loss, the intelligent control switch of the energy storage module 4 and/or the backup power module 5 is turned on, such that the energy storage module 4 and/or the backup power module 5 supply power to the DC output module 3 and the AC output module 4, and supply AC/DC power to the load device to ensure uninterrupted operation of the load device. When the mains power grid 11 of the power supply module 1 is restored, the intelligent control switch of the energy storage module 4 and/or the backup power module 5 may be turned off, and the intelligent control switch of the mains power grid 11 of the power supply module 1 may be turned on, such that the mains power grid 11 of the power supply module 1 supplies power uninterruptedly to the DC output module 3 and the AC output module 4.

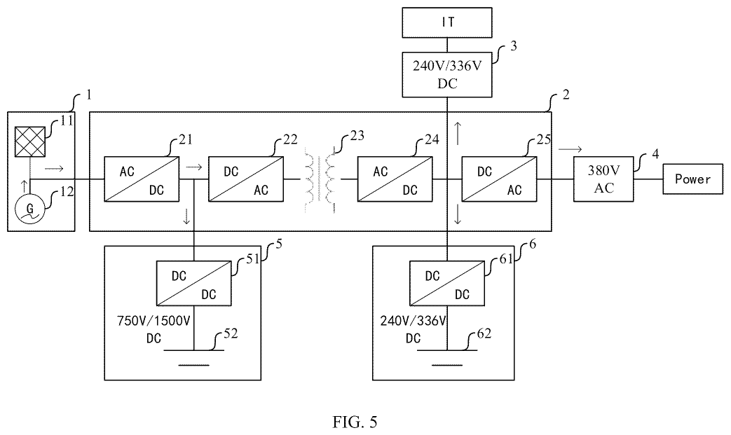

FIG. 5 shows a fourth type of power supply routing of the AC/DC power distribution system for the data center in the present disclosure. When the mains power grid 11 of the power supply module 1 is in the state of power loss for a long time and duration of the loss time is greater than available duration of reserve capacity of the energy storage module 4 or the backup power module 5, the generator 12 of the power supply module 1 is started, such that the generator 12 supplies power to the DC output module 3 and the AC output module 4, and supplies AC/DC power to the load device.

Preferably, in the mains power grid, clean energy is selected as a main electrical energy for use. After voltage transformation, the AC/DC power is outputted to supply electrical energy to the load device to achieve uninterrupted power supply. The generator may be driven by a water turbine, a steam turbine, a diesel engine or other power machinery, to convert energy generated by water flow, air flow, fuel combustion or nuclear fission into mechanical energy, which is transmitted to the generator, such that the generator converts the mechanical energy into the electrical energy to supply power.

By utilizing photovoltaic effects of semiconductor materials, the photovoltaic device converts solar radiation energy into electrical energy. According to real-time electricity prices, peak shaving and valley filling are carried out, and energy storage capacity is configured according to project requirements. Under sunlight, photovoltaics generate the direct current. However, commonly used loads and a vast majority of power machinery in daily life require the alternating current to supply power. Therefore, it is required to convert the direct current generated by photovoltaics into the alternating current with various requirements for different frequencies and voltage values. Necessity of conversion from DC to AC is reflected in a fact that when the power supply system needs to increase or decrease the voltage, only one transformer needs to be additionally provided for an AC system. Advantages of photovoltaic power generation reside in that it neither pollutes environment nor damages ecology, and that it is clean, safe, and renewable.

The photovoltaic device may rely on batteries to store excess electrical energy for power generation. Therefore, during the operation of the photovoltaic device, a case that battery failure adversely affects proper operation of the system may occupy a large proportion. Therefore, selecting an appropriate type of battery, determining an appropriate battery capacity, and accurately implementing installation, operation, and careful maintenance are of great importance to ensure normal operation of photovoltaic power generation. Compared to ordinary lead-acid batteries, which cause greater environmental pollution and require certain maintenance, use of alkaline nickel chromium batteries have advantages of better low-temperature, overcharging, and over-discharging performance, while also causing less environmental pollution.

The battery pack of the backup power module may be configured according to the load device and project requirements. As an independent and reliable operating power source, the battery pack is not affected by the alternating current, and can still ensure continuous and reliable operation even in the event of a power outage or busbar short-circuit in an entire factory. The battery has a stable voltage and a large capacity, and thus is suitable for various complex relay protection and automatic apparatuses, and also is suitable for transmission of various circuit breakers. Therefore, in substations of large enterprises, the battery packs as generally uses as the operating power sources.

In the embodiments of the present disclosure, by arranging a three-level PET topology structure, the AC/DC power distribution system for the data center optimizes a power supply and distribution system link and integrates an energy storage device, such that the power supply module, the energy storage module, the backup power module, the AC output module, and the DC output module are connected to each other. Based on detection and recognition of current power supply and distribution, the control module supplies AC/DC power to the load device by means of the power supply module, the energy storage module, and the backup power module according to demands, thereby avoiding occurrence of intermittent power supply during electricity consumption peak or power outage. In this way, efficiency of the power supply system is improved, energy efficiency is maximized, and rational allocation of resources is ensured.

The AC/DC power distribution system for the data center in the present disclosure adopts a three-level PET topology structure, to provide ports for access of distributed power generation and integrates the energy storage device. Compared with a single-level structure, the three-level PET has a low-voltage DC link, which can integrate the energy storage device, and improve ride-through capability of the PET. Furthermore, its good control characteristics can enable the PET to achieve more functions and provide ports for access of the distributed power generation. Terminal substations of the distributed power generation are independent of each other, and may be subject to self-actuated control by users without large-scale power outages, making them safer and more reliable. Furthermore, the distributed power generation coordinates with the power supply and distribution system to make up for the deficiency of lack of safety and stability of the power grid, thereby ensuring continuous power supply in the event of unexpected disasters. By means of real-time monitoring of quality and performance of regional power, power is supplied according to needs, which can greatly reduce environmental protection pressure.

While ensuring safety and reliability, the embodiments of the present disclosure can effectively integrate the energy storage device, maximize energy efficiency, improve delivery speed, and connect energy storage to achieve peak shaving and valley filling, thereby minimize the electricity costs and ensuring uninterrupted power supply.

The embodiments described above are only illustrated as preferred embodiments of the present disclosure, and are not intended to limit the present disclosure. To those skilled in the art, various modifications and variations may be available for the present disclosure. All modifications, equivalent substitutions and improvements made within the spirit and principle of the present disclosure shall fall within the protection scope of the claims of the present disclosure.

What is claimed is:

1. An AC/DC power distribution system for a data center, comprising a power supply module, a control module, a DC output module, an AC output module, an energy storage module, and a backup power module; wherein
the control module comprises a first rectifier unit, a first inverter unit, a power electronic transformer, a second rectifier unit, and a second inverter unit; and
one end of the first rectifier unit is connected to the power supply module, and other end of the first rectifier unit is connected to the first inverter unit; the energy storage module is further connected between the first rectifier unit and the first inverter unit; the first inverter unit is connected to the power electronic transformer; the power electronic transformer is connected to the second rectifier unit; the second rectifier unit is separately connected to the DC output module and the second inverter unit; and the backup power module is further connected between the second rectifier unit and the second inverter unit.

2. The AC/DC power distribution system according to claim 1, wherein the power supply module comprises a mains power grid or a generator.

3. The AC/DC power distribution system according to claim 1, wherein the energy storage module comprises a DC transformer unit at an energy storage end configured to transform a voltage for a direct current inputted to the energy storage module or outputted from the energy storage module.

4. The AC/DC power distribution system according to claim 3, wherein the energy storage module comprises an energy storage device.

5. The AC/DC power distribution system according to claim 4, wherein the energy storage device comprises a battery pack or a photovoltaic device.

6. The AC/DC power distribution system according to claim 1, wherein the backup power module comprises a DC transformer unit at a backup power end configured to transform a voltage for a direct current inputted to the backup power module or outputted from the backup power module.

7. The AC/DC power distribution system according to claim 6, wherein the backup power module comprises a backup power device.

8. The AC/DC power distribution system according to claim 7, wherein the backup power device comprises a battery pack.

9. The AC/DC power distribution system according to claim 1, wherein the DC output module is configured to supply power to an IT load having a DC voltage of 240V/336V.

10. The AC/DC power distribution system according to claim 1, wherein the AC output module is configured to supply power to a power load having an AC voltage of 380V.
